(19) United States
(12) Patent Application Publication
(10) Pub. No.: US 2011/0199234 A1
(43) Pub. Date: Aug. 18, 2011

(54) Laser guided parking apparatus and method

(76) Inventors: George Butler, III, Mesa, AZ (US); Scott L. Staggers, Mesa, AZ (US)

(21) Appl. No.: 12/803,530

(22) Filed: Jun. 29, 2010

Related U.S. Application Data
(60) Provisional application No. 61/303,696, filed on Feb. 12, 2010.

(51) Int. Cl. B60Q 1/48

(52) U.S. Cl. 340/932.2

(57) ABSTRACT

This abstract describes an apparatus and method for accurately parking a vehicle within an enclosed space such as a garage. The apparatus uses a compact diode laser and is mounted directly to a ceiling or to a device mounted to the ceiling such as a garage door opener unit. When mounted above the vehicle the bright red laser lines are projected from the laser downward and aligned onto a specific surface for the driver to see such as the top surface of a vehicle dashboard. These lines intersect each other forming an ‘X’ (or ‘cross’). This ‘X’ can be aligned with either an existing dashboard feature or with a ‘target’ which is adhered to the dashboard. When a vehicle enters into a garage the first projected laser line that the driver will see will be the longitudinal line. The longitudinal line enables the driver to adjust the vehicle to the right or left as the vehicle continues into the garage. The second projected laser line appears laterally as the driver pulls forward to a stop. When this lateral line and longitudinal line align with the target or other specific location on the dashboard, the driver stops the vehicle. At this point the driver has positioned his vehicle exactly where he wants it to be within the garage.

### CROSS REFERENCE TO RELATED APPLICATIONS

Application no. 61303696, ‘Laser Guided Parking Apparatus and Method’ Dated: 12 Feb. 2010, Inventor: George H. Butler III

### FIELD OF THE INVENTION

The invention relates to an apparatus and method for precisely guiding a vehicle into a preselected parking location. More particularly, the present invention relates to an apparatus which projects a combination of bright laser lines to act as alignment guides for accurately positioning a vehicle inside a garage or other similar area.

### BACKGROUND OF THE INVENTION

The prior art includes numerous devices and methods for guiding a vehicle into an enclosed area such as a garage. Devices using infrared beams, laser dots, laser lines, ultrasonic beams, direct contact switches, microwave beams, etc. The following patents which are each incorporated herein reference, disclose such arrangements:

U.S. Pat. No. 5,285,072 issued to B. White; U.S. Pat. No. 5,878,072 issued to M. Greisz; U.S. Pat. No. 6,040,787 issued to L. Durham; U.S. Pat. No. 6,218,962 B1 D. Fiene; U.S. Pat. No. 6,360,446 B1 V. Bijawat; U.S. Pat. No. 6,531,966 B2 M. Krieger; U.S. Pat. No. 6,772,525 B2 R. Newcomer; U.S. Pat. No. 6,946,973 B1 Leon Yanda; U.S. Pat. No. 7,049,978 B2 Xugang Li; 7,161,498 B1 Xinyue Fan; U.S. Pat. No. 7,573,402, B2 W. Herbert et al; US 2009/0201175 al Patent App J. Pankowski; U.S. Pat. No. 6,853,313 B2 R. Newcomer, This invention uses a ‘Guard Tube’ device to project two linear beams. This device is large, complex and antiquated.

In general these inventions do not combine simplicity, reliability, adjustability and compact design features along with the ability to project highly visible linear lines to accurately guide and position a vehicle to a pre-described location inside a garage or other similar structure. In addition, none of these inventions include a ‘target’ appliqué for use in aligning a vehicle.

### SUMMARY OF THE INVENTION

An object of the invention is to provide an apparatus and method for accurately and easily guiding a vehicle into a garage to a predetermined location.

A further object of the invention is to combine reliable ‘State-of-the-art’ compact diode laser technology with a mounting provision that is simple to install, adjust and utilize for parking a vehicle.

A further object of the invention is to provide an improved method for guiding a vehicle using highly visible linear lines which enable the driver to adjust the vehicle side to side and forward and rearward prior to stopping at a precise location.

A further object of the invention is to provide a means for aligning the ‘cross’ laser beams, such as a ‘target’ appliqué, made from a material that is highly reflective and visible to the driver when struck by the laser beam. This appliqué can be adhered to a surface such as a dashboard and positioned as required for easy view-ability by the driver.

The invention includes an apparatus and method and an article of manufacture for guiding a vehicle precisely into a predetermined parking location. More particularly the present invention relates to an apparatus composed of a currently available compact diode laser unit mounted to a holding device. The holding device (or holder) is designed to hold the laser unit. The holder fits into a base unit which in turn is mounted to the ceiling of the garage above the vehicle to be guided. The combination of laser, holder and base unit allows one to attach, adjust and focus the laser beams quickly, easily and accurately.

Additionally, as a means to activate the device ‘on’ and ‘off’, several options exist.

Option 1, allows the device to be plugged directly into an available electrical outlet provided by and integrated into the garage door opener. This outlet provides the required voltage to operate the laser and is coupled with the garage door opener light. Typically, when the garage door opener is activated to allow a vehicle to enter, the opener light also is activated. With this arrangement the garage door opener assures the parking laser goes on when it is needed and turns off automatically when the garage door opener light goes off.

Option 2, provides a motion detecting device which is combined with a low voltage transformer unit. These combined devices plug directly into the ceiling plug which is typically available for the garage door opener and located centrally on the ceiling. When a vehicle enters the garage the motion sensing (IR) switch will activate the laser unit and after a preset amount of time (several minutes) will turn off automatically. An optional power source can be batteries.

Option 3, uses a light detecting device which is combined with a low voltage transformer unit. These combined devices plug directly into the ceiling plug which is typically available for the garage door opener and located centrally. When a vehicle enters the garage, the light sensing (photovoltaic) switch will activate when it senses the light from the garage door opener. When the garage door opener light goes out, so will the laser. An optional power source can be batteries.

Option 4, provides a sound detecting device which is combined with a low voltage transformer unit. These combined devices plug directly into the ceiling plug which is typically available for the garage door opener and located centrally. When a vehicle enters the garage, the sound sensing (audio-activated) switch will activate when it hears the sound of the garage door opener. When the garage door opener closes and the garage becomes silent, the laser will turn off. An optional power source can be batteries.

The line generating diode laser unit and mounting system provides the user the advantage of mounting the base with either a single screw and/or adhesive tape. The laser holder mounts to the base by way of a fully articulating, (pivot and rotating) ball and socket design. Furthermore, the laser lines can be adjusted and focused to provide the best sharpness by turning the laser tip ring. Once the focus is set, the linear ‘X’ (or ‘cross’) pattern can be rotated (clocked) and positioned using the holder ‘rotation wheel’ and ‘ball and socket’ pivoting mechanisms.

The above objects and advantages of the invention are illustrative and not exhaustive of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE INVENTION

Embodiments of the invention are explained in greater detail by way of drawings, where the same reference numerals refer to the same features.

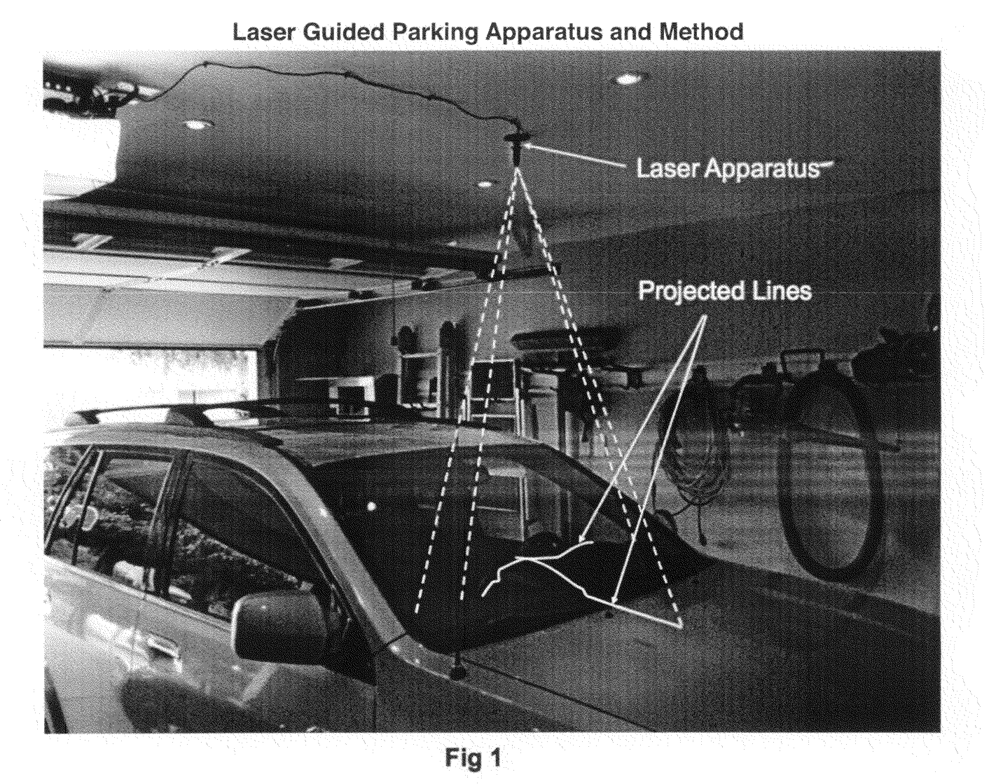

FIG. 1 illustrates an angle view from in front of the vehicle. The laser apparatus is shown projecting a ‘cross’ pattern on the dashboard of the vehicle. Note that the laser line appears irregular from this point of view as it follows the contour of the dashboard.

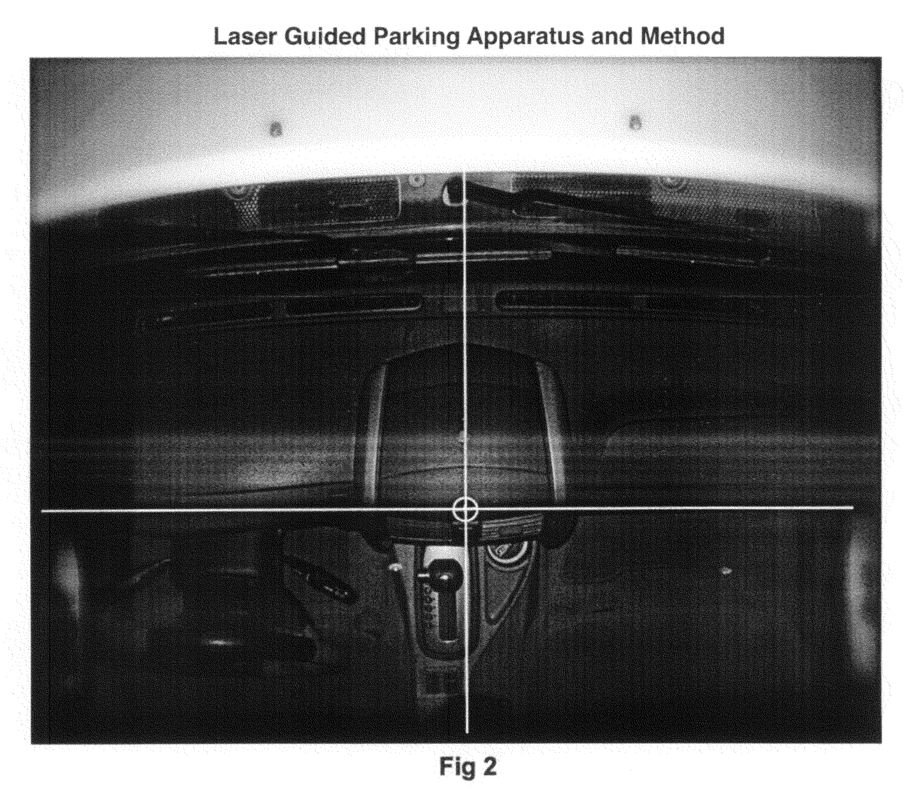

FIG. 2 illustrates a view from the lasers perspective (looking down) of the ‘cross’ pattern projected across the dashboard of a vehicle. From this perspective the projected lines appear straight.

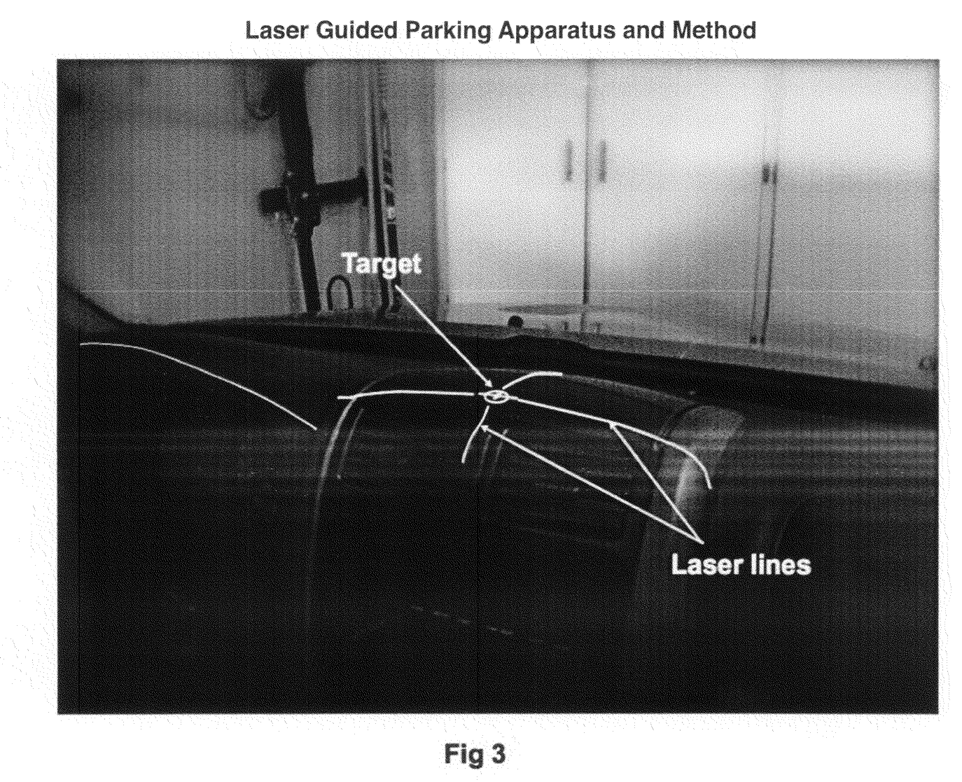

FIG. 3 illustrates a view from a passengers perspective of the projected ‘cross’ pattern as it actually appears on the dashboard of a vehicle. This view is similar to what the driver would see.

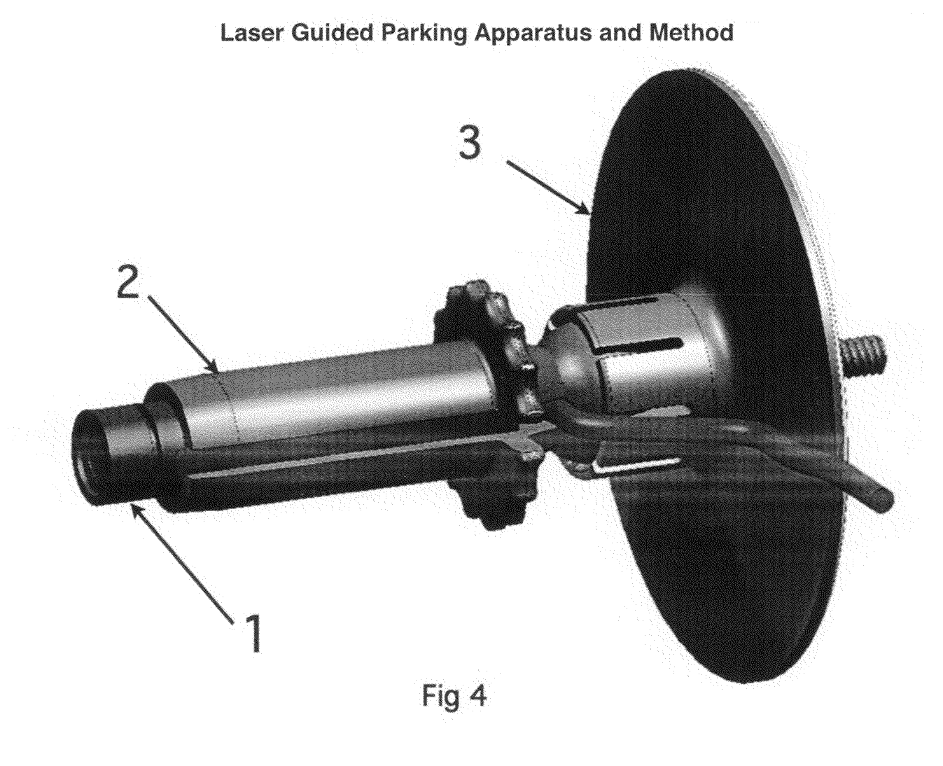

FIG. 4 illustrates the complete assembly of the laser apparatus including the compact laser diode, holder and base unit.

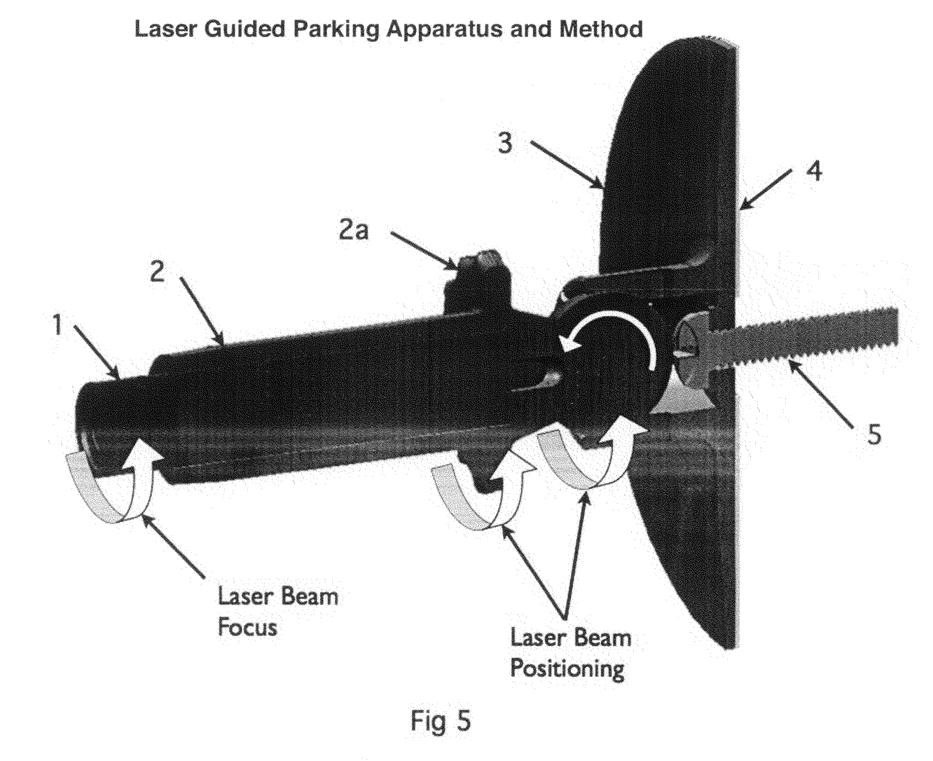

FIG. 5 illustrates a cutaway view of the apparatus and shows the rotational adjustment abilities of the diode laser, holder and base unit. Also shown is the optional attachment method using a screw.

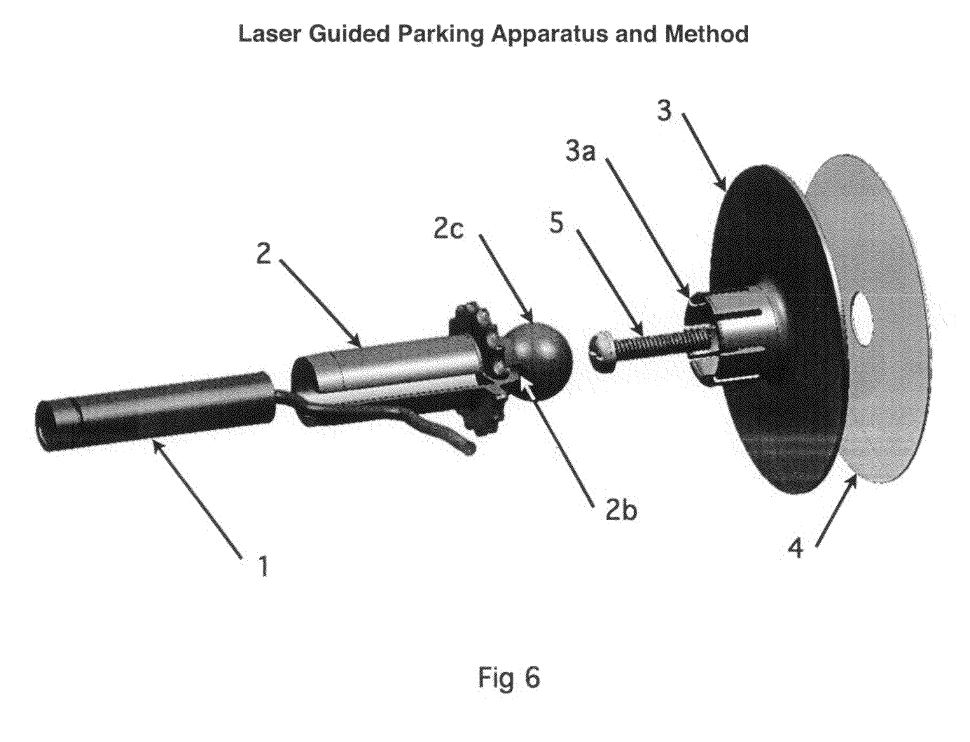

FIG. 6 illustrates an exploded view of the apparatus and all components.

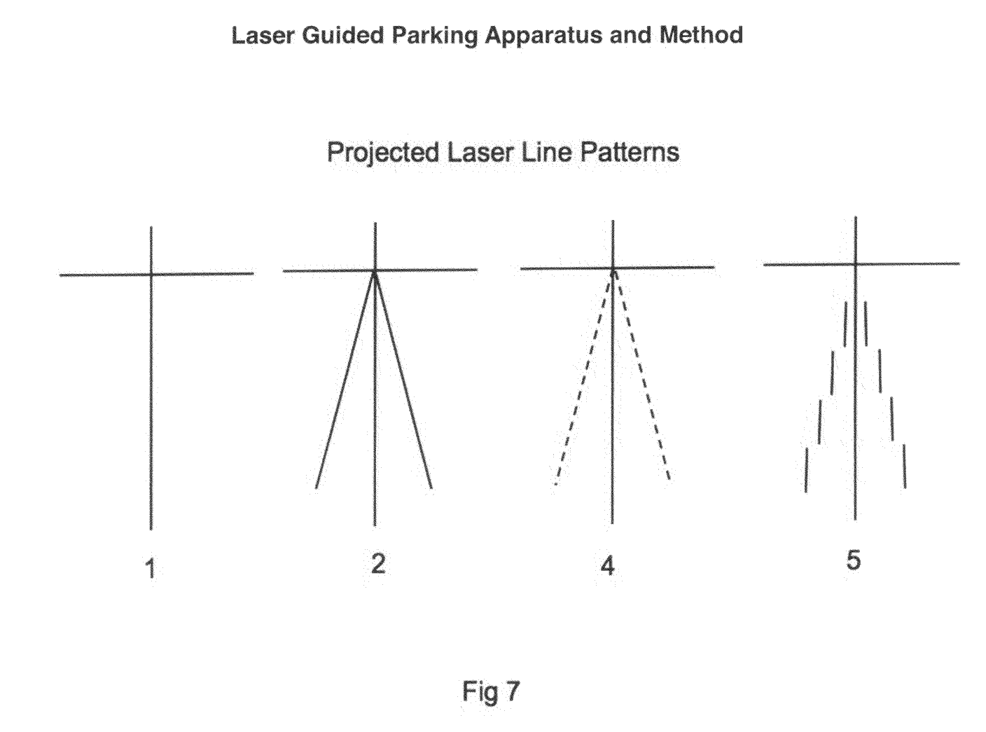

FIG. 7 illustrates several projected laser line patterns which the driver can see and would enable the driver to align and position a vehicle.

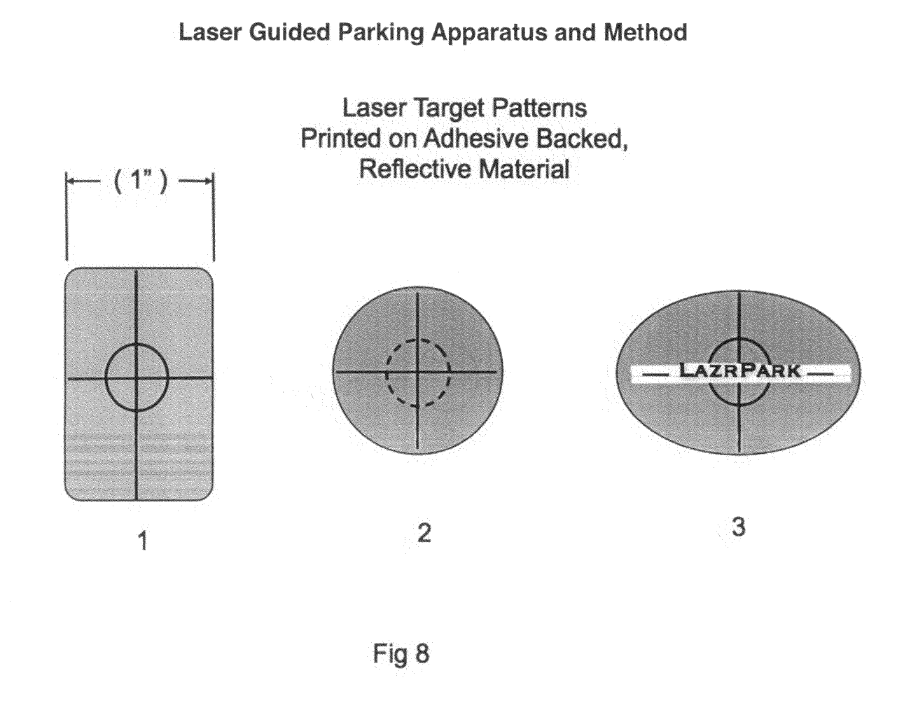

FIG. 8 illustrates several laser ‘target’ designs that consist of graphics printed on an appliquémounted to the top surface of a dashboard of a vehicle for which the laser lines align to.

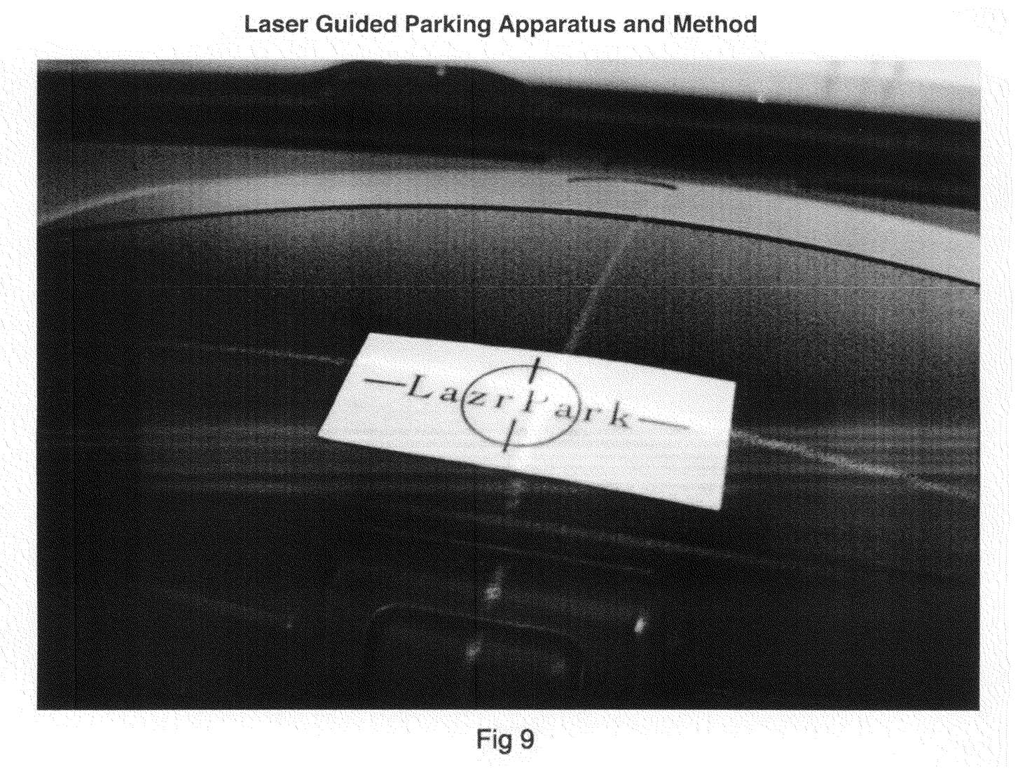

FIG. 9 illustrates the laser lines in alignment with an appliqué mounted to the top surface of a dashboard.

### DETAILED DESCRIPTION OF THE PREFERRED EMBODIMENTS AND METHOD OF OPERATION

As shown in FIGS. 1 through 3 are the illustrative views depicting the linear lines projected from the compact laser apparatus.

As shown in FIGS. 4 through 6 is the preferred embodiment of the precision parking apparatus composed of a compact diode laser 1, a plastic holder with rotation wheel 2, a plastic base 3. Also shown are methods for attachment of the laser apparatus to a garage ceiling or similar structure (above the vehicle) using an adhesive double-sided tape 4, and or a screw 5.

As shown in FIG. 7 is the preferred embodiment of the various laser line patterns that can be projected by the compact diode laser.

As shown in FIG. 8 is the preferred embodiment of the various target designs that is used for aligning the laser ‘cross’ lines to a prescribed location on the dashboard or other similar location on the vehicle. These targets can be printed onto an adhesive backed appliqué material. Note that it is not necessary to have a ‘target’ appliqué but rather, an optional ‘recognizable’ feature on the dashboard may be substituted.

As shown in FIG. 9 the laser lines in alignment with the preferred embodiment of a ‘target’ appliqué attached to the top surface of a dashboard.

Not shown but described later in this document are the sources for power and vehicle detection for this apparatus and method for guiding a vehicle to a precise location within a garage or other similar space.

The method of operation for this laser guiding system requires the laser apparatus be affixed to a location above the vehicle (such as the ceiling in a garage) just above a specific location such as the vehicle's dashboard. Once the laser is attached it may now be adjusted and focused on the prescribed location such as the center of the dashboard so that it is easily seen by the driver, see FIG. 3. Shown in FIG. 3 is a simple laser ‘cross’ pattern. Other patterns may be used (see FIG. 7) that enable the driver to determine the approaching lateral line by way of the angled ‘dashed’ or ‘dotted’ lines. These dashed/dotted lines will appear to converge on the target area as the vehicle moves forward. When the longitudinal and lateral lines converge on the target the driver stops the vehicle. At this point the driver knows that the vehicle is at the predetermined position inside the garage. It is obvious to realize that in some instances the driver may not ‘position’ the vehicle exactly and that the lines may be ‘off’ by a small distance i.e. ½″ in either or both directions. If this occurs the driver may need to readjust the vehicle or leave it ‘as is’ understanding that the vehicle is within a safe margin for avoidance from the garage door or other similar obstruction.

The apparatus for accurately positioning a vehicle into a predetermined space uses a laser 1, see FIG. 4. This commercially available, non patented, compact diode laser unit features a cross-hair laser module that is fully self-contained with integrated laser driver circuit, surface polished glass aspherical lens optics, laser diode and cross-line generator. Unique properties are perfectly straight cross, compact anodized aluminum body, fine adjustable focus, clean coherent beam, low divergence, high bore-sight accuracy and industrial strength. Additionally the laser can project fan angles between 4 and 90 degrees and produce visible light detectable to the human eye with a spectral response between 550-139 nm (nanometers), i.e. The human eye has a spectral response from 400 to 700 nm with peak responsivity at about 550 nm. A variety of unique line patterns can be achieved by this laser as illustrated by FIG. 7. This commercially available laser technology also features a non-hazardous Class II output, operational life of 25,000 to 50,000 hours and a compact size of 12 mm diameter×55 mm long and weighing between 0.5-2.0 oz. Power output is 3-5 Vdc and can be powered by battery or alternate power source.

As shown in FIGS. 4, 5 & 6, is a preferred embodiment of the compact laser 1, holding fixture 2 and base 3. The holding fixture 2, receives the laser module and is designed to allow the laser's electrical cable to pass through the front opening and then along the side ‘slot’ opening of the holder. The compact laser unit slides into the holder and meets with the inside surface of the holder. The electrical cable that protrudes from the end of the compact laser is accommodated by the holder by way of a slot 2b. The holder also encompasses a ball feature 2c which attaches to the ‘socket’ of the base 3. The base 3, is composed of a 75 mm disk and a 18 mm dia. socket 3a. The ball-and-socket meet between the base 3, and holder 2, allows full ‘gimbaling’ adjustment between both these components. FIG. 5 illustrates the rotational and gimbaling abilities of the holding fixture. A notched wheel 2a, allows rotational adjustment of the holder 2, for aligning the laser ‘cross’ on the target. Also shown are attachment features such as double sided tape 4, and a screw 5. Either or both of these attachment methods may be used to affix the laser assembly to the ceiling above the vehicle.

As shown in FIG. 8 are various ‘targets’ composed of a graphic design printed onto a highly reflective appliqué material that has a pressure sensitive backing. This material enhances the illumination of the laser lines at the target site and provides the driver with a specific ‘target’ point. FIG. 9 shows the ‘target’ appliqué affixed to the top of a dashboard.

Not shown but easily understood to those familiar with the art is the power and detection methods to provide the ‘on and off’ capabilities of this invention. Several options exist and are commercially available to apply power and ‘on/off’ control to the laser. An integrated battery pack can be used to power the unit along with either an IR (motion) or photovoltaic (light sensing) or audio sensing sensor that can switch the unit ‘on’ and after a prescribed duration (such as 1-5 minutes) turn the unit ‘off’ by way of a timing circuit. Another method can use a direct connection to the garage door opener. It is clearly understood that most modern garages use an electric garage door opener to open and close the garage door. It is also understood that the mechanism for opening the door is located near the garage ceiling either centrally or near the top of the main garage door. It is also known that such door opening devices have a courtesy light that is activated when the door opens and turns off automatically after a prescribed amount of time, i.e. 1-5 minutes. That said, the compact laser device could, for instance, be plugged directly into this device to acquire both power and ‘on and off’ control. Furthermore, the compact laser device could be incorporated as an integral part of the garage door opener unit supplying the power.

What is claimed is:

1. A parking apparatus and method for accurately guiding a vehicle to a predetermined location within a garage, comprising:
a compact diode laser device capable of projecting highly visible linear lines onto a specific location of a vehicle (such as a dashboard) that the driver can easily see;
a holding fixture comprised of a holder and base unit capable of holding the compact laser and providing full adjustability of the laser beam (lines) focus and beam location;
a compact commercially available diode laser unit that can be configured to project various patterns of bright visible laser lines as to provide enhanced ability for the driver to position the vehicle with ease.

2. The parking apparatus and method of claim 1, whereas the laser lines target an existing unique feature on the dashboard or other area of the vehicle by the driver to align the vehicle accurately.

3. The parking apparatus and method of claim 1, whereas the laser lines are projected onto a specific ‘target’ appliquélocated on the dashboard.

4. The parking apparatus and method of claims 1 & 2 or claims 1 & 3, whereas the power source can be provided by batteries, a transformer, (utilizing 110 V house power) or from a specific garage door opener power source.

5. The parking apparatus and method of claims 1 & 2 or claims 1 & 3, whereas the ‘on and off’ control can be provided by an IR (motion) control switch, a photovoltaic (light sensing) control or audio (sound sensing) switch or through a specific garage door unit interface that provides ‘on and off’ control in conjunction with the door opener courtesy light.
